(19) United States
(12) Patent Application Publication
(10) Pub. No.: US 2020/0387586 A1
(43) Pub. Date: Dec. 10, 2020

(54) Novel and innovative means of providing a versatile and extensible data collection mechanism capable of being easily and securely deployed on most any website, mobile device, or other internet application to leverage cloud-based resources to quantitatively and qualitatively improve the identity verification of individuals

(71) Applicant: Ralph T. Wutscher, Chicago, IL (US)

(72) Inventor: Ralph T. Wutscher, Chicago, IL (US)

(21) Appl. No.: 16/432,097

(22) Filed: Jun. 5, 2019

(51) Int. Cl. G06F 21/31; G06F 21/32; G06F 21/41

(52) U.S. Cl. CPC G06F 21/316; G06F 21/41; G06F 21/32

(57) ABSTRACT

This invention relates to a novel and innovative means and method of providing a versatile and extensible data collection mechanism capable of being easily and securely deployed on most any website, on-device application, or other internet application to leverage cloud-based resources to quantitatively and qualitatively improve the identity verification of individuals. More particularly, this invention relates to a novel and innovative means and method of: (1) employing an adaptable “widget” with plug-in architecture for utilization on existing website, internet accessible portal, or application; (2) securely obtaining and transmitting confidential user information from widget to the verification system; (3) analyzing and evaluating user data points against existing sources of verifiable information to provide a verification rating as to the user identity; and (4) securely storing and transmitting verification rating with client to complete or reject transaction.

### RELATED APPLICATIONS

This application claims priority from Provisional Application Ser. No. 62/763,168.

### FIELD OF THE INVENTION

This invention is called Konfirmi. In part, this invention relates to a novel and innovative means of securely collecting individual items of data or a combination of data from a visitor or user of a website, on-device application, or other internet accessible portal or application. The data is then evaluated and analyzed to create a composite score representing the confidence of the identity verification.

The types of data that can be collected and analyzed through the use and implementation of this invention is unlimited. For example, and without limitation, the individual items of data collected using Konfirmi could include the name, mailing address, email address, telephone number, date of birth, or other identifying data points that could then be used with conventional “knowledge-based authentication” (KBA) resources, or more simply with email or text message verifications, to confirm the identity of the visitor or user. As another example, and again without limitation, the invention could also provide a secure means of collecting fingerprints, retinal scans, voiceprints, or other biometric identifiers of the visitor or user. As another example, and again without limitation, the invention could securely obtain proof of government identification documentation (such as a Driver's License, government issued ID card, or passport), including with or without a verified photograph, of the visitor or user. As another example, and again without limitation, Konfirmi could also be used to securely interface with third-party identification authentication systems such as “single sign on”, blockchain identity verification, and other such third-party systems established to confirm the identity of a visitor or user.

The invention provides a data collection mechanism—or “widget”—that can easily and securely be added to most any website, on-device application, or other internet application. This novel and innovative data collection mechanism is versatile as to how it can be deployed in websites, on-device applications, and other internet applications. It is also easily extensible with respect to the types of data that can be collected once the invention is deployed in connection with a website or other internet application.

Once the data is securely collected, this invention uses various third-party cloud-based data sources, identification systems, and user authentication applications to generate a composite profile of a person's identity. The greater the number of sources and the greater the corroboration of information, the higher the confidence of the identity verification.

As new/improved sources of data become available, their elements can be mapped and added to the system and provide improved analysis and evaluation. A plug-in architecture is provided to easily add/remove/adjust any data source. For example, and without limitation, as more Driver's License image verification systems become available/cost-effective/reliable, more of such third-party systems can be readily added as part of the verification process.

As more data sources are added to the system for verification, the value and related expense of each verification could also rise accordingly. A “waterfall” mechanism has therefore been devised that will limit the number of sources consulted when certain corroboration and/or data quality threshold have been met. A rules-based system is also available to adjust the number of data sources considered based on various transaction metrics.

In addition, once this composite profile has been accumulated, it can be further augmented and updated and correspondingly can increase or decrease the confidence level of an identity.

As verification activity continues over time for an individual, the composite profile's quality can be ranked higher whether the analysis indicates that the identity is true or false.

The invention also provides a method to amend identity profiles based on the verifier's transactions with the individual. This allows the verifier to leverage proprietary knowledge on a case by case basis.

The invention uses a customizable weighting of data analysis to determine the overall score for the identity verification. This allows each verifier the ability to contextually tailor evaluations. Additionally, rules can be defined to approve/reject verifications for specific data circumstances.

This invention also provides for creating a network of identity verifications that can be securely and consensually shared with other verifiers.

Konfirmi accomplishes all of these goals in a novel and innovative method that is both highly secure and easy to implement.

### BACKGROUND OF THE INVENTION

This invention arose from the universal need of businesses and other organizations to verify the identity of individual that they transact with over the internet. This is especially true for financial services and other companies that have “Know Your Customer” (KYC), Anti Money Laundering (AML), age verification, location verification, and other legal or regulatory requirements that mandate identifying a visitor or user of a website or other application, and/or verifying various aspects of the visitor or user.

Identity verification using existing identity verification schemes require the visitor or user to provide various types of data which then need to be verified. This level of friction at the initial engagement can often lead to abandonment by the user. If the verifier does not obtain quality corroboration of the data provided, the transaction might be erroneously declined. Or without sufficient verification, the transaction may be approved, and fraud could result.

Existing identity verification systems are also often difficult and expensive to implement and maintain, making the systems out of reach for many small business and other companies of more limited means.

As additional cloud-based data sources become available, they each offer a unique collection of identity verification elements. Existing data-based identity verification systems therefore, out of necessity, rely on a fixed set of sources. Over time as better sources of identity verification data become available, the confidence level in legacy fixed data source systems declines, and the need for multi-source and overlapping verification systems increases.

Also, existing verification systems rely on a “one-size-fits-all” approach every transaction. There is no ability to adjust the process based on unique attributes of each transaction. Therefore, each verification using existing systems is performed in the same context. If a partial verification is reported, further human evaluation may be required to determine if the corroboration is satisfactory for the verifier. This delay can lead to the individual to abandon the transaction. The need for human evaluation also increases costs and adds greater possibility for bias or other error.

Even when a human subjectively approves a partial corroboration, and proceeds with the transaction, the results of this approval and the resulting transaction have no value for other verifiers. For example, Mr. John Doe may have limited information in the cloud-based third-party data sources. XYZ Corporation subjectively decides based on the partial corroboration of verification systems to proceed with the transaction. The positive/negative outcome of this transaction has no bearing on the next verifier of Mr. John Doe's identity.

Also, to limit the monetary and other cost of verifications, a “waterfall” system has been devised. This allows the verifier to rank data sources by cost (or any arbitrary priority) and stop further verifications when a confidence threshold has been achieved. Various other thresholds can be established via a rules-based system and any available data parameters. For example, and without limitation, higher value transactions can be subjected to extra-cost data sources and identification systems to achieve a higher level of verification confidence.

In addition, Konfirmi provides a blockchain ledger of previous verifications of an individual, along with a journal of successful and unsuccessful transactions between the individual and the verifiers. This augmented report can provide a more reliable basis for further verification when external data sources have limited or no verification data for an individual.

Further, this blockchain identity verification data can be selectively and securely shared based on contractual rules between the individual and the verifiers. This collection of blockchain identity verification information can serve as a circle of trust for the involved parties and thereby increase the quality of identity verifications and reduce friction of subsequent transactions.

### SUMMARY OF THE INVENTION

The method and the system of this invention center around the innovative concepts of providing:
1. A novel and innovative mechanism for collecting identification-related data that is both highly secure and relatively easy to implement.
2. A novel and innovative mechanism for collecting an infinite variety of identification-related data that is both versatile as to how it can be deployed in websites, on-device applications, and other internet applications, and easily extensible with respect to the types of data that can be collected once the invention is deployed in connection with a website, on-device application, or other internet application.
3. A secure and reliable means of collecting individual items of data or a combination of data of virtually any kind from a visitor or user of a website, on-device application, or other internet accessible portal or application. For examples, and without limitation, the data collected could consist of:
   a. The email address, telephone number, or other identifying data points that could then be used with conventional messaging systems to identify the visitor or user; and/or
   b. The name, mailing address, email address, date of birth or other identifying data points that could then be used with conventional “knowledge-based authentication” (KBA) resources to confirm the identity of the visitor or user; and/or
   c. Fingerprints, retinal scans, voiceprints, or other biometric identifiers of the visitor or user; and/or
   d. Proof of government identification documentation (such as a Driver's License, state ID card, or passport), including with or without a verified photograph; and/or
   d. A token or other authorization method from third-party identification authentication systems such as “single sign on”, blockchain identity verification, and other such third-party systems.
4. A configurable set of cloud-based data sources, identification systems, and authentication applications for identity verifications of individuals.
5. Adjustable weighting/scoring of collected data elements and thresholds for matching.
6. Secure storage of identity verification history and optionally, subsequent transactions, on a blockchain, digitally signed and encrypted by both parties.
7. A method of securely and selectively sharing and adding to the verification and transaction history by other identity verifiers that wish to participate in the circle of trust.
8. An easy to use method of adding new cloud-based information sources as they become available with assignable correlation among heterogenous schemas using a plug-in architecture.
9. A unique solution to limiting cost of identity verifications by the “waterfall” techniques described above.
10. A rules-based verification system to tailor verification methodology based any available data parameters for each transaction.
11. A facility for reporting and analyzing verification and transaction history to help make informed decisions on high risk verifications—for example, and without limitation, due to lack of verifiable data and/or when large value transactions are pending.
12. A facility allowing manual over-ride of automated verifications, as well as blacklisting and whitelisting of verification data characteristics and patterns.

### BRIEF DESCRIPTION OF DRAWING

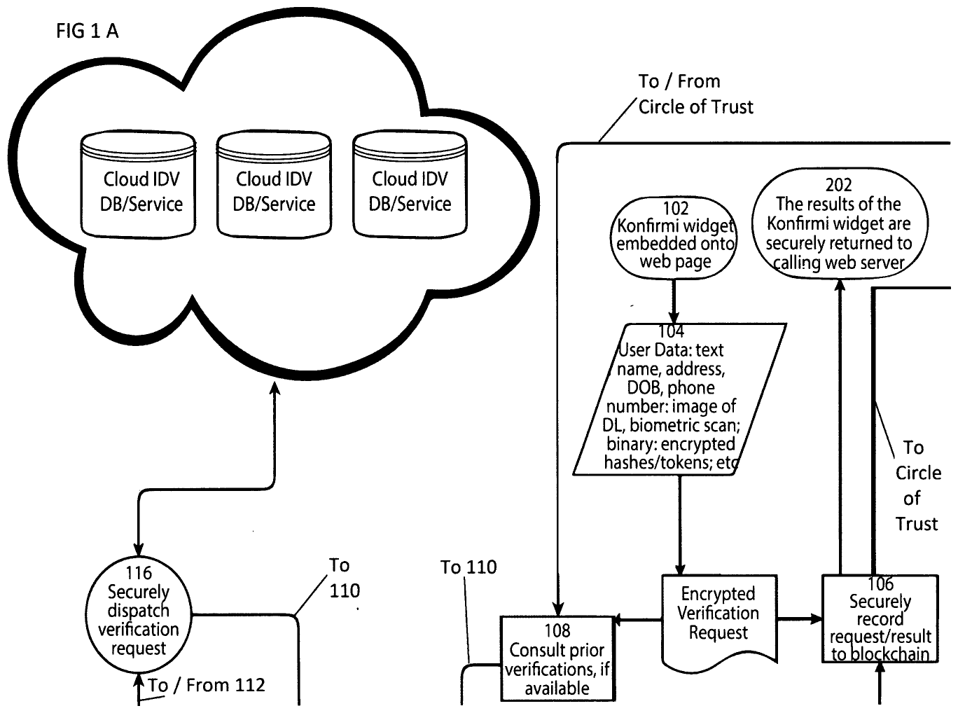

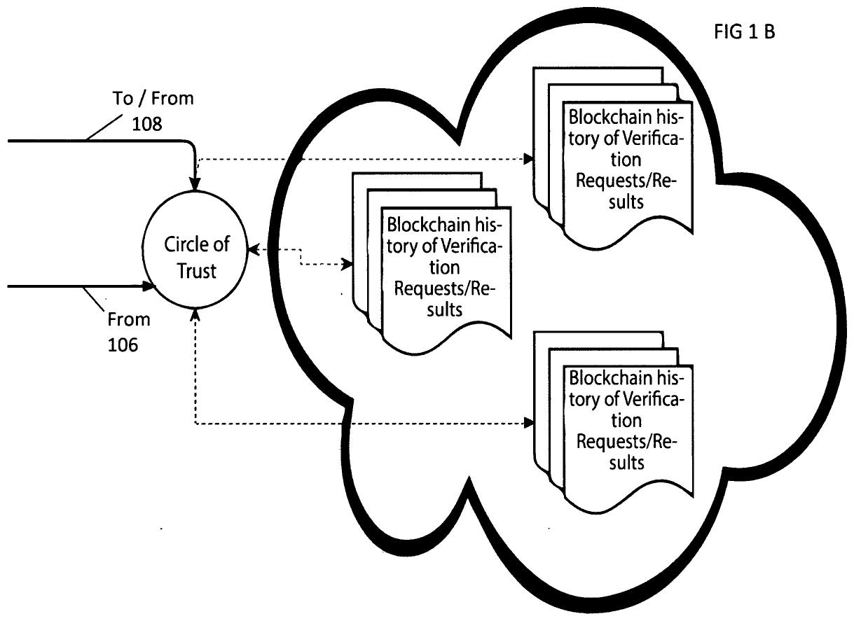

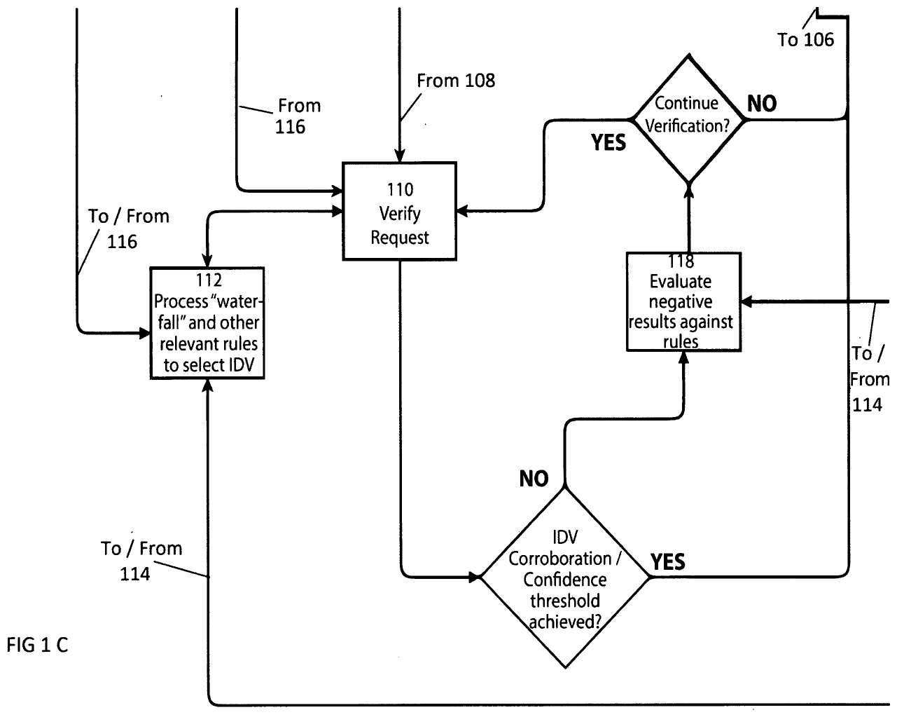

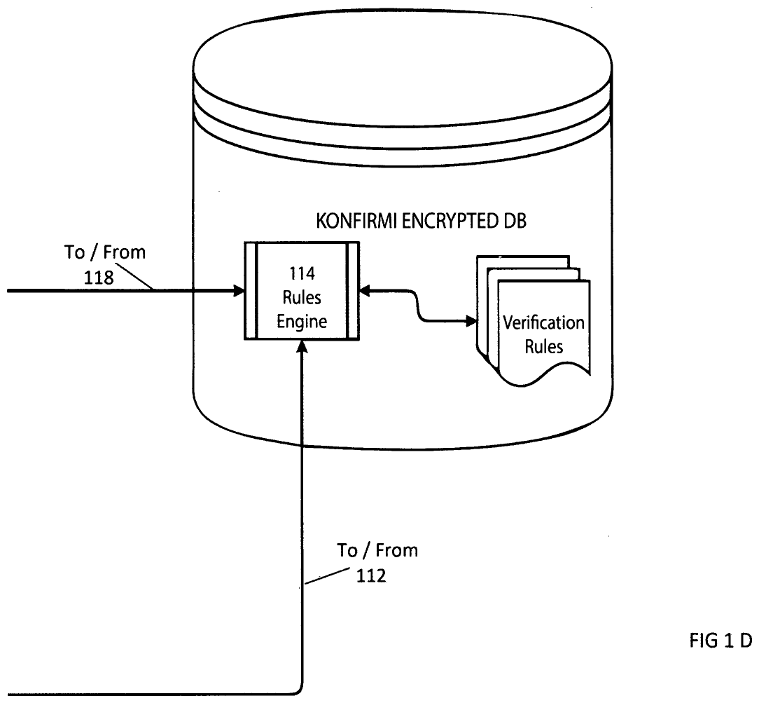

Referencing FIG. 1 A:
102. The Konfirmi mechanism or “widget” is easily and securely embedded into the verifier's secure web page, on-device application, or other web-facing application. Upon the occurrence of an event defined by the verifier, the Konfirmi widget appears, and the visitor or user is prompted to enter/upload various forms of identity verification data, including but not limited to:
   a. Name
   b. Address
   c. Telephone Number
   d. Date of Birth
   e. Image of Driver's License
   f. Security Token
   g. Biometric Data
   h. Any other data types or sources, as outlined in the Summary of Invention section above.
104. An encrypted document of the verification data is generated and transmitted to the Konfirmi system as a verification request.

Referencing FIG. 1 B:
106. The request/result of the verification is logged in the “Circle of Trust” and forwarded back to the calling web server hosting the Konfirmi widget in STEP 202.
Here, the Circle of Trust consists of an external blockchain ledger, used alone or in combination with a secure and encrypted internal database.
The external blockchain ledger and/or internal database are used to securely store encrypted records of previous verifications of an individual, along with a journal of successful and unsuccessful transactions between the individual and the verifiers.
The encrypted records of previous verification can be used to generate augmented reports that can provide a more reliable basis for further verification when external data sources have limited or no verification data for an individual.
In addition, the encrypted identity verification data—stored in the external blockchain ledger and/or in the internal database—can be selectively and securely shared based on contractual rules between the individual and the verifiers.
This collection of external blockchain and/or internal database identity verification information serves as a circle of trust for the involved parties, and thereby increases the quality of identity verifications and reduces friction in subsequent transactions.
108. A check is made against the Circle of Trust blockchain for any prior verifications that may be shared for this user.

Referencing FIG. 1 C:
110. The verification process is begun. If no prior verification data was made available in STEP 108 (FIG. 1 A), we proceed with consulting one or more Cloud Identification Verifiers (Cloud IDV).
Once a response is received from the request dispatcher in STEP 110, a check is made of the verification request results. If the verification is positive, we securely record the result in the Circle of Trust blockchain network in STEP 106 (FIG. 1 A).
If prior verification data is received from the Circle of Trust blockchain (FIG. 1 B), it is treated as a verification request and if positive, we proceed as above.
In the case that the new verification request or the Circle of Trust blockchain returns a negative result, we proceed to STEP 11.8.
112. A secure verification request document is received, and Konfirmi Rules Engine is consulted.

Referencing FIG. 1 D:
114. The Rules Engine processes the verification request and any additional information contained in the request and returns the document with either a decision or requirements for further verifications.

Referencing FIG. 1 A:
116. The response from the rules engine (STEP 114, FIG. 1 D) is used to securely dispatch the verification request. The request is made to the Cloud IDV as specified from the rules engine. The response is returned to the Verify Request process in Step 110. 118. When a negative confirmation is received, the Konfirmi Rules Engine in STEP 114 (FIG. 1 D) is consulted. If the response is to continue verification, we return to STEP 110. If the response is to halt further verification, we transmit the negative response and result to STEP 106 (FIG. 1 A).

The invention claimed is:

1. A method for the use of computer software to securely collect individual items of data or a combination of data of virtually any kind from a visitor or user of a website, on-device application, or other internet accessible portal or application, and evaluate the visitor or user data to create a composite score representing the confidence of the identity verification for said visitor or user, comprising:
Embedding the computer software (“widget”) into the client's web page, on-device application, or other web-facing application (“platform”);
Upon the occurrence of an event defined by the client, presenting a mechanism or “widget” to the visitor or user of the client's platform;
Securely and easily obtaining information, images, videos, audio recordings, or other data from the visitor or user of the client's platform through the widget;
Encrypting data provided by visitor or user to the client's platform;
Transmitting encrypted data provided by visitor or user into the widget to the secure and encrypted cloud-based claimed computer software;
Evaluating and comparing the visitor or user data against verifiable Cloud Identification Verifiers (“Cloud IDV”), including but not limited to:
a. Prior user or visitor verifications extant in the claimed software database;
b. Conventional “knowledge based authentication” resources;
c. Government provided identification documents with or without verified photograph;
d. A token or other authorization method from third-party identification authentication systems such as “single sign on”, blockchain identity verification, and other such third-party systems;
e. Biometric data, including but not limited to fingerprints, retinal scans, voiceprints;
Creating a verification score based upon previously selected criteria input by the client following a completion of the evaluation of the visitor or user datapoints against the Cloud IDV;
Generating an output through the widget to the user or visitor of the client's website with confirmation or rejection of the user or visitor's identity or requirements for additional verification data points;
Employing multiple factor and layer waterfall applications of the process based upon the client needs for reliability of user identification.

2. A computer system implementing the method in claim 1, comprising:
A computer readable medium for the storing and processing of computer code;
Computer code for storing and retrieving data entries stored on a computer readable medium;
Computer code for interface through an application program interface (API);
Computer code for evaluating and parsing user data points utilizing a rules engine;
Computer code for encrypting and transmitting user data points;
Computer code for data entry by user through the API including through text, biometric, documents, photographic, voice entry, and other data types on both fixed and mobile devices;
Computer code for submitting queries to the Cloud IDV utilizing the API for retrieving specific information contained in the database and producing a report and graphical display of same; and

3. The system described in claim No. 2, with access to the API through a portable or mobile device.
